(19) United States
(12) Patent Application Publication
(10) Pub. No.: US 2021/0164825 A1
(43) Pub. Date: Jun. 3, 2021

(54) METHOD AND SYSTEM FOR DETECTING AND MEASURING LIQUID

(71) Applicant: BOE TECHNOLOGY GROUP CO., LTD., Beijing (CN)

(72) Inventors: Changfeng LI, Beijing (CN); Xue DONG, Beijing (CN); Haisheng WANG, Beijing (CN); Yingming LIU, Beijing (CN); Xiaoliang DING, Beijing (CN); Yanling HAN, Beijing (CN)

(21) Appl. No.: 16/641,495

(22) PCT Filed: Apr. 26, 2019
(86) PCT No.: PCT/CN2019/084538

§ 371 Date: Feb. 24, 2020

(30) Foreign Application Priority Data
May 25, 2018 (CN) 201810517448.9

(51) Int. Cl. G01F 23/292; G01F 23/24

(52) U.S. Cl. CPC G01F 23/2925; G01F 23/242

(57) ABSTRACT

A method for measuring a liquid includes the steps of providing a microfluidic device which is configured to contain a liquid to be measured and include a plurality of predetermined measurement regions, wherein a plurality of photosensors are disposed at the plurality of predetermined measurement regions, irradiating light of constant intensity onto the microfluidic device so that at least one photosensor of the plurality of photosensors receives light passing through the liquid, acquiring a plurality of photocurrent values output by the plurality of photosensors, and measuring the physical parameters of the liquid according to the plurality of photocurrent values.

### CROSS REFERENCE TO RELATED APPLICATIONS

This application claims the priority of Chinese patent application No. 201810517448.9 filed on May 25, 2018, the entire content of which is hereby incorporated by reference.

### TECHNICAL FIELD

The present disclosure relates to the technical field of microfluidic devices, in particular to a method and system for detection and measurement (hereinafter referred to as measurement for short) of a liquid.

### BACKGROUND

Microfluidic system is a device or system that controls the movement of a fine droplet to carry out physical and chemical reactions, biological detection and other experiments. In the experimental process such as chemical reaction and biological detection using the microfluidic system, it is necessary to detect the physical and chemical properties of the droplet placed in the microfluidic device in real time, such as concentration, position, size, shape and temperature and other information. Because the measurements of the droplet are very small, it is difficult for the experimenter to measure the concentration, position, size, shape and temperature and other information of the droplet in real time by traditional methods. In addition, physical parameters such as position, size, shape, concentration when reacting and temperature are likely to change in real time during the movement of the fine droplet. Therefore, there is an urgent need for a method and system capable of measuring physical parameters of liquid placed in a microfluidic device in real time to meet the needs of carrying out chemical reaction, biological detection and other experimental processes using the microfluidic system.

### SUMMARY

An aspect of the present disclosure provides a method for measuring a liquid, comprising:

providing a microfluidic device which is configured to contain a liquid to be measured and include a plurality of predetermined measurement regions at which a plurality of photosensors are provided;

irradiating light of constant intensity onto the microfluidic device so that at least one photosensor of the plurality of photosensors receives light passing through the liquid;

acquiring a plurality of photocurrent values output by the plurality of photosensors; and

measuring physical parameters of the liquid according to the plurality of photocurrent values.

According to an aspect of the present disclosure, acquiring the plurality of photocurrent values output by the plurality of photosensors includes acquiring the plurality of photocurrent values output by the plurality of photosensors in real time during the movement of the liquid.

According to an aspect of the present disclosure, measuring the physical parameters of the liquid according to the plurality of photocurrent values includes measuring the physical parameters of the liquid in real time according to the plurality of photocurrent values.

According to an aspect of the present disclosure, measuring the physical parameters of the liquid according to the plurality of photocurrent values comprises: finding out at least one photocurrent value from the plurality of photocurrent values as a target photocurrent value; and measuring one or more of the physical parameters of the liquid according to the at least one target photocurrent value.

According to an aspect of the present disclosure, measuring one or more of the physical parameters of the liquid according to the at least one target photocurrent value includes measuring a concentration of the liquid based on a first predetermined relationship between photocurrent and concentration according to the at least one target photocurrent value.

According to an aspect of the present disclosure, measuring one or more of the physical parameters of the liquid according to the at least one target photocurrent value includes measuring one or more of a position, size and shape of the liquid according to the predetermined measurement region where the photosensor corresponding to the target photocurrent value is located.

According to an aspect of the present disclosure, finding out at least one photocurrent value from the plurality of photocurrent values as a target photocurrent value comprises:

as for each photocurrent value of the plurality of photocurrent values, finding out a historical measurement value of the photosensor corresponding to the photocurrent value,

comparing the current photocurrent value with the historical measurement value to obtain a difference value, and

selecting a corresponding photocurrent value with a difference value larger than a first predetermined threshold value as the target photocurrent value.

According to an aspect of the present disclosure, finding out at least one photocurrent value from the plurality of photocurrent values as a target photocurrent value comprises:

comparing each photocurrent value of the plurality of photocurrent values with other photocurrent values to obtain a difference value, and

selecting a corresponding photocurrent value with a difference value larger than a second predetermined threshold value as the target photocurrent value.

According to an aspect of the present disclosure, a temperature sensor is provided on at least a portion of the plurality of predetermined measurement regions, the method further comprising:

measuring the temperature of the liquid by the temperature sensor.

Another aspect of the present disclosure provides a system for measuring a liquid, comprising:

a microfluidic device which is configured to contain a liquid to be measured and includes a plurality of predetermined measurement regions at which a plurality of photosensors are disposed;

a light source which is configured to irradiate light of constant intensity onto the microfluidic device such that at least one photosensor of the plurality of photosensors receives light passing through the liquid;

a current measurement unit which is configured to acquire a plurality of photocurrent values output by the plurality of photosensors and measure physical parameters of the liquid according to the plurality of photocurrent values.

According to an aspect of the present disclosure, the current measurement unit is configured to acquire the plurality of photocurrent values output by the plurality of photosensors in real time during the movement of the liquid; and measure the physical parameters of the liquid in real time according to the plurality of photocurrent values.

According to an aspect of the present disclosure, the current measurement unit is configured to:

find out at least one photocurrent value from the plurality of photocurrent values as a target photocurrent value; and

measure one or more of the physical parameters of the liquid according to the at least one target photocurrent value.

According to an aspect of the present disclosure, the current measurement unit includes at least one of:

a first measurement submodule which is configured to measure a concentration of the liquid based on a first predetermined relationship between photocurrent and concentration according to the at least one target photocurrent value, or

a second measurement submodule configured to:

according to the predetermined measurement region where the photosensor corresponding to the target photocurrent value is located, measure one or more of the position, size and shape of the liquid.

According to an aspect of the present disclosure, the plurality of photosensors are arranged in an array, the input end of each photosensor of the same row is connected to the same gate line, and the output end of each photosensor of the same column is connected to the same data line to acquire the plurality of photocurrent values.

According to an aspect of the present disclosure, the system for measuring a liquid further comprises:

a temperature sensor disposed on at least a portion of the plurality of predetermined measurement regions; and

a temperature measurement unit configured to measure a temperature of the liquid according to an output of the temperature sensor.

Another aspect of the present disclosure also provides a microfluidic device comprising:

a first substrate and a second substrate opposite to each other, and

an accommodation space between the first substrate and the second substrate for accommodating a liquid to be measured,

wherein a plurality of predetermined measurement regions are arranged in the second substrate, and at least one photosensor is arranged in the plurality of predetermined measurement regions.

According to an aspect of the present disclosure, the photosensor includes a photodiode and a thin film transistor for controlling on and off of the photodiode, wherein the photodiode is a PIN type photodiode, and the thin film transistor is an alpha-Si type thin film transistor.

According to an aspect of the present disclosure, the first substrate, and the second substrate respectively include a glass plate, a dielectric layer, and a hydrophobic layer disposed from outside to inside, wherein the hydrophobic layer is made of Telfon material to facilitate the liquid to move within the microfluidic device, and

wherein the microfluidic device further comprises two drive electrodes respectively formed on the first substrate and the second substrate, wherein one drive electrode is connected to a drive power supply and the other drive electrode is grounded, thereby driving the liquid to move within the microfluidic device.

According to an aspect of the present disclosure, the number of photosensors is plural, wherein the plurality of photosensors are arranged in an array, the input end of each photosensor in the same row is connected to the same gate line, and the output end of each photosensor in the same column is connected to the same data line to acquire the plural photocurrent values.

According to an aspect of the present disclosure, at least one temperature sensor is further provided in the plurality of predetermined measurement regions for measuring the temperature of the liquid.

### BRIEF DESCRIPTION OF THE DRAWINGS

FIG. 1 is a schematic cross-sectional view of a system for measuring a liquid according to some exemplary embodiments of the present disclosure.

FIG. 2 is a schematic cross-sectional structural view of a portion of a system for measuring a liquid according to some exemplary embodiments of the present disclosure.

FIG. 3 is a structural block diagram of a current measurement unit according to some exemplary embodiments of the present disclosure.

FIG. 4 is a schematic view of an array arrangement of photosensors according to some exemplary embodiments of the present disclosure.

FIG. 5 is a schematic view of a connection structure of a single photosensor in the photosensor array shown in FIG. 4.

FIG. 6 is a schematic view of the principle for driving a liquid in a microfluidic device according to some exemplary embodiments of the present disclosure.

FIG. 7 schematically shows how to acquire a plurality of photocurrent values using the photosensors arranged in an array shown in FIG. 4.

FIG. 8 is a flow chart of a method for measuring a liquid according to some exemplary embodiments of the present disclosure.

### DETAILED DESCRIPTION

Various aspects and features of the present disclosure are described below with reference to the accompanying drawings. These and other features of the present disclosure will become apparent from the following description of certain forms of embodiments as non-limiting examples with reference to the accompanying drawings.

The phrase “in one embodiment”, “in another embodiment”, “in yet another embodiment”, or “in other embodiments” may be used in this specification, which may all refer to the same embodiment or one or more of different embodiments according to the present disclosure. Note that throughout the specification, the same reference numerals refer to the same or similar elements, and unnecessary repetitive descriptions are omitted. Furthermore, in specific embodiments, elements appearing in the singular do not exclude that they may appear in multiple (plural) forms.

As used herein, “electrical connection” between two components/elements/devices includes direct electrical connection or indirect electrical connection between the two. Indirect electrical connection between the two can be realized, for example, by providing a conductive substance (e.g., metal) between the two.

An object of the present disclosure is to provide a method and system capable of measuring physical parameters of a liquid placed in a microfluidic device in real time.

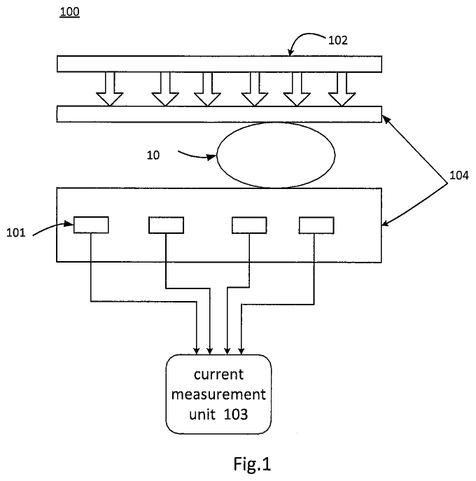

FIG. 1 is a schematic cross-sectional view of a system for measuring a liquid according to some exemplary embodiments of the present disclosure. As shown in FIG. 1, a system 100 (hereinafter referred to as system 100) for measuring a liquid according to some exemplary embodiments of the present disclosure includes photosensors 101, a light source 102, and a current measurement unit 103.

The photosensors 101 are disposed at a plurality of predetermined measurement regions of the microfluidic device 104. The photosensor 101 can receive and sense light it receives and generate photocurrent corresponding to the received light. That is, when lights of different intensities are irradiated onto the photosensors 101, the photosensors 101 generate photocurrents of different intensities (magnitudes).

As shown in FIG. 1, the plurality of photosensors 101 are disposed at a plurality of measurement regions on a substrate at one side of the microfluidic device 104 in the system 100. One or more photosensors 101 are arranged to receive light passing through the liquid 10 and generate corresponding photocurrent during movement of the liquid. Due to the presence of liquid, the photocurrent signals received by the photosensor 101 that receives light passing through the liquid 10 and the photosensor 101 that receives light not passing through the liquid (e.g., the photosensor 101 that is remote from the liquid) are different. Moreover, the photocurrent will change continuously according to the real-time movement of liquid. By analyzing these photocurrent values, the physical parameters of the liquid can be measured in real time.

Various measurement regions may be uniformly distributed, or may be more densely distributed in key regions (e.g., regions scheduled for biochemical reactions) as required.

The light source in the embodiment of the present disclosure is a light source capable of emitting light of constant intensity (i.e., a stable light source of constant wavelength). When light of constant intensity is irradiated onto the microfluidic device 104 on which the liquid is placed, one or more photosensors 101 can receive light passing through the liquid, while other photosensors 101 receive light not passing through the liquid. The light source may be, for example, a point light source, a surface light source, or a combination of a plurality of point light sources as long as the requirement of constant intensity is met.

The current measurement unit 103 is configured to acquire a plurality of photocurrent values output by the plurality of photosensors 101 in real time during the movement of the liquid, and measure physical parameters of the liquid in real time according to the plurality of photocurrent values. Some of these output photocurrent values correspond to light passing through the liquid and some correspond to light not passing through the liquid. Since the input light intensity is constant, there is distinguishability between the output photocurrent values during the liquid movement, and this distinguishability is related to the physical parameters of the liquid.

The measured physical parameters of the liquid may include, for example but not limited to, one or more of position, size, shape, concentration, etc.

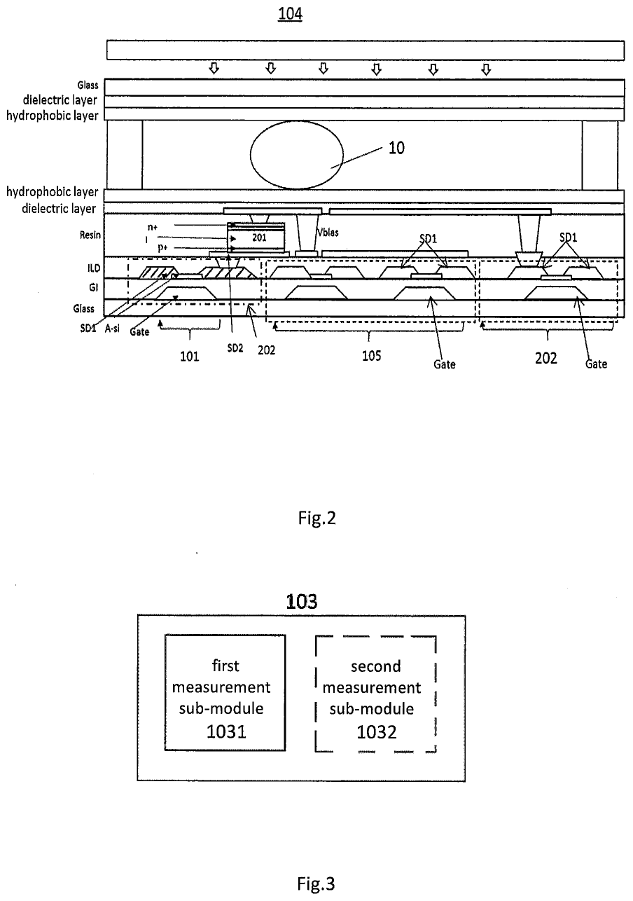

FIG. 2 is a schematic cross-sectional structural view of a part of a system for measuring a liquid according to some exemplary embodiments of the present disclosure, which shows a schematic cross-sectional structural view of a microfluidic device 104, and also shows a position where a photosensor 101 is disposed in the microfluidic device 104 and an exemplary structure thereof.

A typical microfluidic device (also called microfluidic chip) has two glass substrates (Glass), which are opposite to each other. A dielectric layer and a hydrophobic layer are sequentially formed on the glass substrate. The hydrophobic layer may be made of, for example, Telfon material to facilitate the liquid to move within the microfluidic device. Drive electrodes (not shown) are respectively formed on the upper and lower glass substrates, wherein the electrode on one of the glass substrates can be supplied with a driving voltage, and the electrode on the other glass substrate can be grounded, thereby driving the liquid 10 to move within the microfluidic device 104.

In this embodiment, the photosensor 101 may be integrated in the microfluidic device 104, for example. The photosensor 101, also known as a light sensing measurer, may include, for example, a structure shown in the lower left part of FIG. 2, i.e., includes a thin film transistor (TFT) 202 and a photodiode 201, the upper electrode of which is connected to a constant voltage Vbias, and the lower electrode is electrically connected to a source or drain of the thin film transistor 202 via a conductive substance SD2 (e.g., metal). The thin film transistor 202 is indicated by a dot-dashed box in the lower left part of FIG. 2, which includes a source, a drain, a gate (Gate), and an α-Si semiconductor layer connected between the source and the drain. The source and the drain are indicated by SD1. If the left half of SD1 is a source, the right half is a drain, and vice versa.

When the photodiode 201 is irradiated with light, a current through the photodiode is generated between the upper electrode and the lower electrode. The current flows through one of the source or drain of the thin film transistor connected with the photodiode, and flows to the other of the source or drain through the α-Si semiconductor layer, the other of the source or drain being electrically connected to the current measurement unit IC (not shown in FIG. 2) so that the current measurement unit IC reads out the current value. When lights of different intensities are irradiated onto the photodiode, photocurrents of different magnitudes will be generated, and the current values can be read out by the current measurement unit IC.

An exemplary structure of the photodiode 201 is composed of PIN junction as shown in FIG. 2, and includes an n+ layer, an I layer and a P+ layer from top to bottom. The structure of the photodiode disclosed herein is only an example and should not be considered as a limitation of the present disclosure.

Note that although the thin film transistor specifically shown in FIG. 1 is an α-Si thin film transistor, an oxide TFT or a low temperature polycrystalline thin film transistor may also be used. In other words, the present disclosure does not limit the specific type of thin film transistor.

In FIG. 2, a PIN diode is integrated in a microfluidic chip using an organic layer, such as a resin layer (shown as Resin in the figure). The resin layer (Resin) is a planarization layer thicker than the PIN diode, and may be formed on the glass substrate of the microfluidic chip using, for example, a doctor blade process or a spin coating process. A thin film transistor is integrated on the glass substrate (Glass). As shown in the figure, inorganic layers GI and ILD are formed on the glass substrate. The GI layer is a gate insulating layer which can be made of silicon nitride, silicon oxide or the like. The ILD layer is an insulating layer on which the source and drain of the thin film transistor are respectively formed.

An exemplary composition of the current measurement unit will be described below. As an example, the current measurement unit may be specifically configured to find out at least one photocurrent value from a plurality of photocurrent values as a target photocurrent value; and measure one or more of physical parameters of a liquid droplet in real time according to the at least one target photocurrent value.

An exemplary method of determining a target photocurrent value according to some exemplary embodiments of the present disclosure is described below.

As an example, as for each photocurrent value of the plurality of photocurrent values, a historical measurement value of the photosensor corresponding to the photocurrent value is found out, a current photocurrent value is compared with the historical measurement value to obtain a difference value, and a corresponding photocurrent value with a difference value larger than a first predetermined threshold value is selected as the target photocurrent value. That is, a vertical comparison method.

As another example, as for each photocurrent value of the plurality of photocurrent values, it is compared with other photocurrent values to obtain a difference value, and a corresponding photocurrent value with a difference value greater than a second predetermined threshold value is selected as the target photocurrent value. That is, a horizontal comparison method.

The target photocurrent value may be one or more. Under normal circumstances, it is likely to measure more than one target photocurrent value, depending on the size, shape and position of the liquid (or droplet).

For example, in order to realize the purpose of measuring the physical parameters of liquid droplets in real time according to the found at least one target photocurrent value, the current measurement unit may include a current value measurement circuit to acquire a plurality of photocurrent values output by the plurality of photosensors 101 in real time, and may include a processing circuit, such as a circuit with calculation processing capability such as a single chip microcomputer, DSP, FPGA and the like, which may analyze the physical parameters of liquid according to the plurality of photocurrent values to obtain a real-time measurement result. For example, when the physical parameter to be analyzed is concentration, such analysis may be performed according to a predetermined relationship between photocurrent and droplet concentration. In this case, as shown in FIG. 3, the current measurement unit may include a first measurement sub-module 1031 for measuring the concentration of the liquid, which is configured to measure the concentration of the liquid in real time based on a first predetermined relationship between photocurrent and concentration according to at least one target photocurrent value.

The first predetermined relationship between photocurrent and droplet concentration may be already stored in advance in a storage medium, which may be integrated in the processing circuit or not integrated in the processing circuit but as an external memory. Therefore, the current measurement unit can acquire the predetermined relationship from the storage medium. Examples of the storage medium may include, but are not limited to, read-only memory, power-down nonvolatile memory, and the like.

For example, a first predetermined relationship between photocurrent and droplet concentration may be acquired and stored in a storage medium in the following manner. In the following example, how to calibrate a standard photocurrent-droplet concentration curve in advance is described.

Under a given experimental environment (in order to ensure accuracy, a light source of constant size and the same measurement device or a measurement device of the same model are required), corresponding current values are read for given droplet concentrations, so that a standard photocurrent-droplet concentration curve is calibrated in advance. When the droplet concentration needs to be measured, the droplet concentration is obtained according to a standard photocurrent-droplet concentration curve calibrated in advance based on the current value currently read. For example, in a current measurement unit including a DSP circuit as a processing circuit, photocurrent and droplet concentration may be stored one-to-one in a tabular form. In practical application, the photocurrent value currently measured can be used to quickly determine the droplet concentration by looking up the table. It is to be noted that this is only an example and should not be taken as a limitation on the present disclosure.

In addition, a standard photocurrent-droplet concentration curve can be calibrated in advance for a droplet of each kind in the above manner.

In addition, the first predetermined relationship between photocurrent and droplet concentration may be expressed in other forms than the photocurrent-droplet concentration curve. For example, under a given experimental environment (a light source of constant size, the same measurement device or a measurement device of the same model, and a given specific droplet), the corresponding current value is read for a given droplet concentration, and then the relationship expression between photocurrent and droplet concentration is fitted based on these data. When a droplet concentration needs to be measured, the droplet concentration can be easily calculated based on the read photocurrent value according to the relationship expression between photocurrent and droplet concentration.

In another example, the current measurement unit 103 may include a current value measurement circuit and a computing device in which the current value measurement circuit outputs a current value to the computing device, such as a computer or the like. Based on the read photocurrent value, the liquid droplet concentration is calculated by the computing device according to a first predetermined relationship between photocurrent and liquid droplet concentration.

In some exemplary embodiments according to the present disclosure, as shown in FIG. 3, the current measurement unit 103 may further include a second measurement sub-module 1032 for determining and measuring one or more of the position, size and shape of the liquid in real time according to one or more of the position, size and shape of a predetermined measurement region where the photosensor 101 corresponding to at least one target photocurrent value is located. This will be described in some exemplary embodiments below. It should be noted that the second measurement sub-module 1032 is not necessary, but may be provided as required.

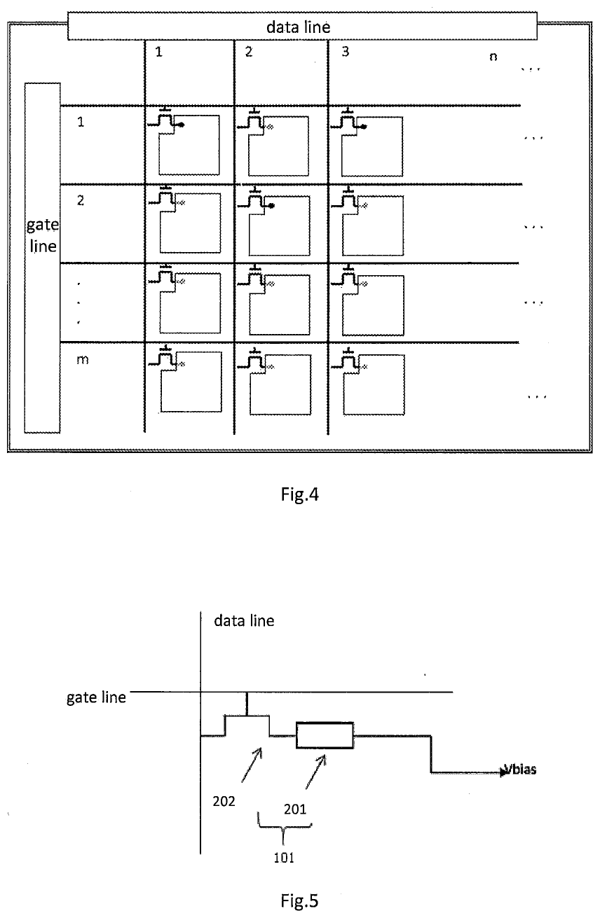

FIG. 4 shows a schematic view of an array arrangement of photosensors according to some exemplary embodiments of the present disclosure. The input end of each photosensor in the same row is connected to the same gate line, and the output end of each photosensor in the same column is connected to the same data line to acquire a plurality of photocurrent values.

FIG. 5 is a schematic view of a connection structure of a single photosensor in the photosensor array shown in FIG. 4. In each photosensor 101, the photodiode 202 is a PIN photodiode, but is not limited thereto, and any other type of photodiode may be used. One electrode of each PIN photodiode 202 is controlled to be turned on or off by a TFT electrically connected thereto. The other electrode of the PIN photodiode 202 is controlled by a voltage Vbias, and, for example, the voltage may be about-5 to 1V. Each row of gate lines can be turned on for scanning on a row-by-row basis according to a given timing, and photocurrent information generated by the PIN photodiode 202 in each row is read by a corresponding column data line.

Next, the situation where the second measurement sub-module 1032 measures one or more of the position, size and shape of the liquid in real time will be described in detail.

Firstly, the principle of controlling a droplet to move by a microfluidic device is described.

The basic principle of droplet movement in the microfluidic device is: a drive electrode is controlled by a switching TFT in the microfluidic system, and different voltage values are given to the drive electrode, while the voltage of the drive electrode will cause different contact angles (also called infiltrating angle or wetting angle) between the droplet and the contact surface, thus realizing droplet movement.

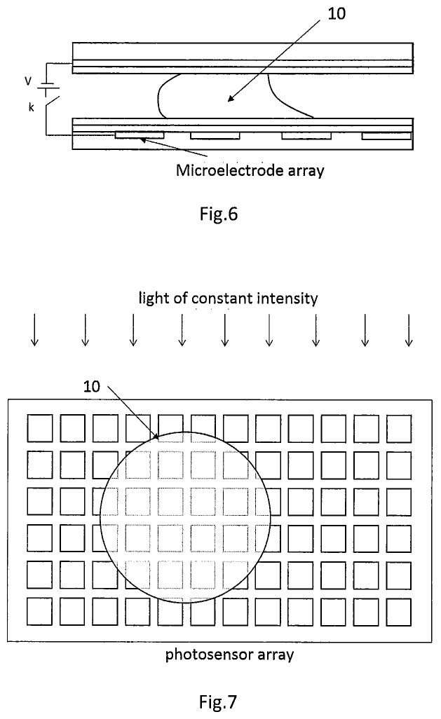

Specifically, as shown in FIG. 6, this is a schematic view of the liquid driving principle in the microfluidic device according to some exemplary embodiments of the present disclosure, and shows the situation where a liquid droplet 10 is driven when a power supply (voltage V) is applied between microelectrodes on the upper and lower substrates of the microfluidic device. When a switch K is open, the contact angles between the droplet and the upper and lower electrode plate are the contact angles defined by Young's equation. When the switch K is closed, the applied voltage acts on the interface between the droplet and the lower electrode plate, so the contact angle is defined by L-Young's equation. Therefore, this contact angle decreases obviously, while the contact angle at the left end of the droplet remains unchanged. Asymmetric deformation of the droplet generates internal pressure difference, thus driving the liquid.

Referring again to FIG. 2, the dashed box in the lower right corner of FIG. 2 shows the microstructure of the switching TFT. That is, the switching TFT can be configured to control the driving of the droplet by the microfluidic device. Typically, the switching TFT in the microfluidic device is also arranged in an array to realize accurate driving of the liquid droplet to a predetermined position.

In the following example, the second measurement sub-module 1032 is specifically described to measure information such as the concentration, position, size, shape, etc. of the liquid droplet. As shown in FIG. 4, the photosensors are arranged in an array. When the droplet 10 moves to a certain position, the droplet 10 will block a part of the light from the light source above, resulting in a regional change in the signal received by the photosensor array. Therefore, the size and position information of the droplet can be measured.

FIG. 7 is a schematic view of an array of photocurrent data obtained using the photosensors arranged in the array shown in FIG. 4, in which an array of 6*12 is adaptively shown. In conjunction with FIG. 4, when the horizontal gate scanning line is turned on, the vertical data lines receive 12 columns of data, thus acquiring a data array of 6*12 size. If the droplet moves to an area marked by a circle (hereinafter referred to as “marked area”) in the figure, the differences between the data values in the circle and the data values outside the circle are represented by different gray values, then the value of each data in the marked area will be greatly changed with respect to the data values in other positions (which may be referred to as “horizontal comparison”). For example, in the example of FIG. 7, if the value of each data in the marked area will be greatly changed with respect to the data values of other positions, it is determined that the position of the marked area is the position where the droplet is located, the size of the marked area may correspond to the size of the droplet, and the shape of the marked area may correspond to the shape of the droplet. In addition or alternatively, if the current value of each data in the marked area is greatly changed with respect to the previously stored historical value of each data in the marked area, it can also be determined that the marked area is an area where regional changes occur (which can be referred to as “vertical comparison”), then it can be determined that the position of the marked area is the position where the droplet is located, the size of the marked area corresponds to the size of the droplet, and its shape corresponds to the shape of the droplet.

The inventor of the present application has designed various specific determination methods, for example, comparing the data of a single position in the array with the average value of data of the whole array to find out the data of a single position with large variation amplitude. Alternatively, a search area of a predetermined size is set to sequentially search for area that meet the change amplitude reaching a predetermined value on the data array. When the droplet is approximately circular, the area of the predetermined size can be set to 3*3 or 4*4 or 5*5 or the like. If the droplet is more approximately elliptical, the area of the predetermined size can be set to 3*4 or 3*5 or the like. This is just an example. There are many ways to search for areas with regional changes, and it is not limited to the examples given here.

At the same time, as for different droplet concentrations, the blocked light intensity information is different, resulting in different signal amounts (i.e., current intensities) in local areas of the sensor array where the droplet is located. According to the size of each data in the marked area, the real-time concentration information of the droplet can be determined based on the first predetermined relationship between photocurrent value and concentrations.

Thus, the size, shape, position and concentration of the liquid droplet can be simultaneously measured in real time. Of course, only some of the physical parameters provided above can be measured as required.

In some exemplary embodiments, the system 100 may further include a temperature sensor 105 (shown in FIG. 2) and a temperature measurement unit (not shown in the figure). The temperature measurement unit is configured to measure the temperature of the liquid according to the output of the temperature sensor.

The temperature sensor 105 may be disposed on at least a portion of a plurality of predetermined measurement regions, that is, the temperature sensor 105 may be disposed as required, for example, at a position where a biochemical reaction is performed on the liquid droplet, wherein the temperature of the reaction process needs to be measured, and thus the temperature sensor 105 is mainly disposed at such a position. Thus, the cost of the system 100 can be reduced.

In addition, a temperature sensor 105 may be provided at each predetermined measurement region.

As an example, the temperature sensor 105 can be implemented by a ring oscillator, which is composed of a plurality of thin film transistors. As shown in the dashed box in the lower middle of FIG. 2, a schematic view of the temperature sensor 105 is shown. The temperature measurement principle is that the temperature affects the characteristics of the TFT channel, causing the current output to change, and the current change causes the frequency of the ring oscillator to change.

Correspondingly, the temperature measurement unit may determine the temperature of the liquid based on a second predetermined relationship between the frequency value and the droplet temperature determined experimentally in advance according to the measured frequency value.

In other exemplary embodiments, the temperature sensor 105 may be implemented by a PIN junction, and its temperature measurement principle is that temperature affects the carrier condition of the PIN junction, thereby affecting the output of current.

Correspondingly, the temperature measurement unit may determine the temperature of the liquid based on a third predetermined relationship between the current value and the droplet temperature determined experimentally in advance according to the measured current value.

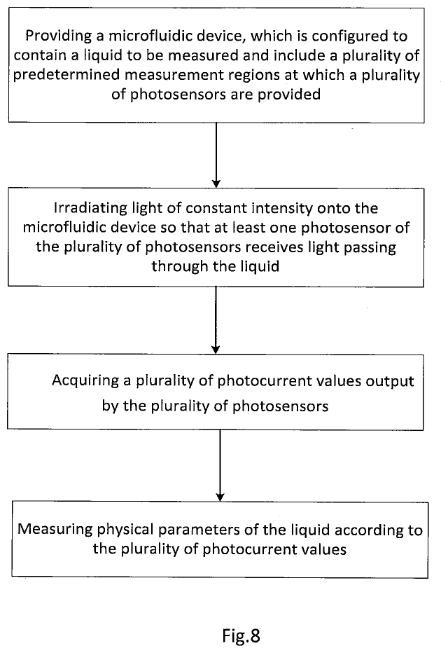

In the following embodiments, there is provided a method for measuring a liquid, as shown in FIG. 8, which includes:

irradiating light of constant intensity onto the microfluidic device on which the liquid is placed so that at least one photosensor of the photosensors disposed at a plurality of predetermined measurement regions of the microfluidic device receives light passing through the liquid;

in the process of liquid movement, acquiring a plurality of photocurrent values output by the plurality of photosensors in real time;

according to the plurality of photocurrent values, measuring the physical parameters of the liquid in real time.

With the liquid measurement system and method of the present embodiment, by applying light of constant intensity to the microfluidic device and causing at least one photosensor of the photosensors disposed at the plurality of predetermined measurement regions to receive light passing through the liquid, i.e., the magnitude of the photocurrent generated by the at least one photosensor is related to the liquid, while the photocurrent values generated by the remaining photosensors receiving light not passing through the liquid are different from the photocurrent value of the photosensor receiving light passing through the liquid. Since the light intensity is constant, the photocurrent values acquired in real time can be compared during liquid movement, and then the physical parameters of the liquid can be measured more accurately in real time by analyzing the photocurrent values acquired in real time.

In one example, physical parameters of a liquid are measured in real time according to a plurality of photocurrent values, including: finding out at least one target photocurrent value from the plurality of photocurrent values; according to at least one target photocurrent value, measuring one or more of the physical parameters of the droplet in real time.

According to some exemplary embodiments of the present disclosure, finding out at least one target photocurrent value from a plurality of photocurrent values includes: as for each photocurrent value of the plurality of photocurrent values, finding out a photocurrent value having a difference greater than a first predetermined threshold value as a target photocurrent value by comparing it with a historical measurement value of the photosensor corresponding to the photocurrent value; or alternatively, as for each photocurrent value of the plurality of photocurrent values, finding out a photocurrent value with a difference larger than a second predetermined threshold value as a target photocurrent value by comparing it with other photocurrent values.

According to other exemplary embodiments of the present disclosure, the concentration of the liquid may be measured in real time based on a first predetermined relationship between photocurrent and concentration according to at least one target photocurrent value.

According to still other exemplary embodiments of the present disclosure, one or more of the position, size and shape of the liquid can be measured in real time according to a predetermined measurement region where a photosensor corresponding to at least one target photocurrent value is located.

According to still further exemplary embodiments of the present disclosure, a temperature sensor may be provided on at least a portion of a plurality of predetermined measurement regions, and the method for measuring the liquid further includes measuring the temperature of the liquid using the temperature sensor.

The process of liquid movement may include the whole process or part of the process before, during and after the movement, and may also include when the liquid is in a stopped state. That is, in the process of real-time measurement of the physical property of the liquid, the physical property of the liquid in the stopped state may also be measured, or only during a part of the process of the liquid from a stopped state to moving to a predetermined position, the physical property may be measured, which does not affect the implementation of the present disclosure according to the spirit and essence of the present disclosure.

The method and system for measuring a liquid according to the present disclosure have the beneficial effects as follows. Light of constant intensity is applied to a microfluidic device, and at least one of photosensors arranged at a plurality of predetermined measurement regions receives light passing through the liquid, that is, the magnitude of photocurrent generated by the at least one photosensor is related to the liquid, while the photocurrent values generated by other photosensors receiving light not passing through the liquid are different from the photocurrent value of the photosensor receiving light passing through the liquid. Since the light intensity is constant, the photocurrent values acquired in real time can be compared in the process of liquid movement, and then the physical parameters of the liquid can be measured more accurately in real time by analyzing the photocurrent values acquired in real time.

As for the non-exhaustive description of the method embodiments of the present disclosure, reference may be made to the description of the aforementioned device embodiments.

It should be understood that although various features and beneficial effects of the present disclosure and specific details of is the structure and function of the present disclosure have been set forth in the above description, these are merely exemplary, and the specific details thereof, especially the shape, size, number and arrangement of components, may be specifically changed within the scope of the principles of the present disclosure to the overall scope represented by the broad general meaning as claimed in the claims of the present disclosure.

Unless otherwise defined, all technical and scientific terms used in this specification have the same meaning as commonly understood by those skilled in the art to which this disclosure belongs.

The “devices”, “modules” and the like in various embodiments of the present disclosure may be implemented by using hardware units, software units, or combinations thereof. Examples of hardware units may include devices, components, processors, microprocessors, circuits, circuit elements (e.g., transistors, resistors, capacitors, inductors, etc.), integrated circuits, application specific integrated circuits (ASIC), programmable logic devices (PLD), digital signal processors (DSP), field programmable gate arrays (FPGA), memory units, logic gates, registers, semiconductor devices, chips, microchips, chipsets, etc. Examples of software units may include software components, programs, applications, computer programs, application programs, system programs, machine programs, operating system software, middleware, firmware, software modules, routines, subroutines, functions, methods, procedures, software interfaces, application program interfaces (API), instruction sets, computing codes, computer codes, code segments, computer code segments, words, values, symbols, or any combination thereof. Determining whether an embodiment is implemented through the use of hardware units and/or software units may vary according to any number of factors, such as a desired calculation rate, power level, heat resistance, processing cycle budget, input data rate, output data rate, memory resources, data bus speed, and other design or performance constraints, as desired for a given implementation.

Those skilled in the art will understand the term “substantially” herein (such as in “substantially all light” or in “substantially consist of”). The term “substantially” may also include embodiments having “wholly”, “completely”, “all”, etc. Therefore, in the embodiment, the adjective is also substantially removable. Where applicable, the term “substantially” may also refer to 90% or more, such as 95% or more, specifically 99% or more, even more specifically 99.5% or more, including 100%. The term “comprising” also includes embodiments in which the term “comprising” means “consisting of”. The term “and/or” specifically refers to one or more of the items mentioned before and after “and/or”. For example, the phrase “item 1 and/or item 2” and similar phrases may relate to one or more of items 1 and 2. The term “comprising” may refer to “consisting of” in one embodiment, but may also refer to “including at least a defined category and optionally one or more other categories” in another embodiment.

Furthermore, the terms first, second, third, etc. in this specification and in the claims are used to distinguish between similar elements and do not denote any order, quantity, or importance. It should be understood that the terms so used are interchangeable under appropriate circumstances and that the embodiments of the present disclosure described herein are capable of operation in a different order than described or illustrated herein.

“Up”, “Down”, “Left” and “Right” are only used to indicate the relative positional relationship. When the absolute position of the described object changes, the relative positional relationship may also change accordingly.

It should be noted that the above-mentioned embodiments illustrate rather than limit the present disclosure, and that those skilled in the art will be able to design many alternative embodiments without departing from the scope of the appended claims. In the claims, any reference signs placed between parentheses shall not be construed as limiting the claims. The use of the verb “to include” and its conjugations does not exclude the presence of elements or steps other than those stated in a claim. The words “a” or “an” in the claims of the present disclosure do not exclude plural numbers, and are only intended for convenience of description and should not be construed as limiting the scope of protection of the present disclosure.

The present disclosure may be implemented by means of hardware comprising several distinct elements, and by means of a suitably programmed computer. In the device claim enumerating several devices, several of these devices can be embodied by the same item of hardware. The mere fact that certain measures are recited in mutually different dependent claims does not indicate that a combination of these measures cannot be used to advantage.

The present disclosure is further applicable to devices that include one or more of the characterizing features described in this specification and/or shown in the drawings. The present disclosure further relates to methods or processes that include one or more of the characterizing features described in this specification and/or shown in the drawings.

The various aspects discussed in this patent may be combined to provide additional advantages. In addition, those skilled in the art will understand that embodiments can be combined, and more than two embodiments can also be combined. In addition, some features may form the basis of one or more divisional applications.

1. A method for measuring a liquid, comprising:
providing a microfluidic device that is configured to contain the liquid to be measured, and comprising a plurality of predetermined measurement regions that comprise respective ones of a plurality of photosensors;
irradiating light of constant intensity onto the microfluidic device so that at least one photosensor of the plurality of photosensors receives light passing through the liquid;
acquiring a plurality of photocurrent values that are output by the plurality of photosensors; and
measuring physical parameters of the liquid according to the plurality of photocurrent values.

2. The method according to claim 1, wherein the acquiring the plurality of photocurrent values output by the plurality of photosensors comprises:
acquiring the plurality of photocurrent values that are output by the plurality of photosensors in real time during a movement of the liquid.

3. The method according to claim 2, wherein the measuring the physical parameters of the liquid according to the plurality of photocurrent values comprises:
measuring the physical parameters of the liquid in real time according to the plurality of photocurrent values.

4. The method according to claim 1, wherein the measuring the physical parameters of the liquid according to the plurality of photocurrent values comprises:
determining at least one photocurrent value from the plurality of photocurrent values as a target photocurrent value; and
measuring one or more of the physical parameters of the liquid according to the target photocurrent value.

5. The method according to claim 4, wherein the measuring one or more of the physical parameters of the liquid according to the target photocurrent value comprises:
measuring a concentration of the liquid based on a first predetermined relationship between photocurrent and concentration according to the target photocurrent value.

6. The method according to claim 4, wherein, the measuring one or more of the physical parameters of the liquid according to the target photocurrent value comprises:
measuring one or more of a position, size or shape of the liquid according to a predetermined measurement region where a photosensor of the plurality of photosensors corresponding to the target photocurrent value is located.

7. The method according to claim 4, wherein the determining at least one photocurrent value from the plurality of photocurrent values as the target photocurrent value comprises:
for each photocurrent value of the plurality of photocurrent values, determining a historical measurement value of a photosensor of the plurality of photosensors corresponding to the photocurrent value,
comparing a current photocurrent value with the historical measurement value to obtain a difference value, and
selecting a corresponding photocurrent value with the difference value larger than a first predetermined threshold value as the target photocurrent value.

8. The method according to claim 4, wherein the determining at least one photocurrent value from the plurality of photocurrent values as the target photocurrent value comprises:
comparing each photocurrent value of the plurality of photocurrent values with other photocurrent values to obtain a difference value, and
selecting a corresponding photocurrent value with the difference value larger than a second predetermined threshold value as the target photocurrent value.

9. The method according to claim 1, wherein a temperature sensor is in at least a portion of the plurality of predetermined measurement regions, and wherein the method further comprises:
measuring a temperature of the liquid by the temperature sensor.

10. A system for measuring a liquid, comprising:
a microfluidic device configured to contain a liquid to be measured, and comprising a plurality of predetermined measurement regions that comprise a plurality of photosensors;
a light source configured to irradiate light of constant intensity onto the microfluidic device such that at least one photosensor of the plurality of photosensors receives light passing through the liquid; and
a current measurement unit configured to acquire a plurality of photocurrent values that are output by the plurality of photosensors and measure physical parameters of the liquid according to the plurality of photocurrent values.

11. The system according to claim 10, wherein the current measurement unit is configured to perform operations comprising:
acquiring the plurality of photocurrent values that are output by the plurality of photosensors in real time during a movement of the liquid; and
measuring the physical parameters of the liquid in real time according to the plurality of photocurrent values.

12. The system according to claim 10, wherein the current measurement unit is configured to perform operations comprising:
determining at least one photocurrent value from the plurality of photocurrent values as a target photocurrent value; and
measuring one or more of the physical parameters of the liquid according to the target photocurrent value.

13. The system according to claim 12, wherein the current measurement unit comprises at least one of:
a first measurement submodule configured to measure a concentration of the liquid based on a first predetermined relationship between photocurrent and concentration according to the target photocurrent value, or
a second measurement submodule configured to measure one or more of a position, size or shape of the liquid according to a predetermined measurement region where a photosensor of the plurality of photosensors corresponding to the target photocurrent value is located.

14. The system according to claim 10,
wherein the plurality of photosensors are arranged in an array,
wherein an input end of each photosensor in a same row is connected to a same gate line, and
wherein an output end of each photosensor in a same column is connected to a same data line to acquire the plurality of photocurrent values.

15. The system according to claim 10, further comprising:
a temperature sensor on at least a portion of the plurality of predetermined measurement regions; and
a temperature measurement unit configured to measure a temperature of the liquid according to an output of the temperature sensor.

16. A microfluidic device comprising:
a first substrate and a second substrate opposite to each other, and
an accommodation space between the first substrate and the second substrate for accommodating a liquid to be measured,
wherein a plurality of predetermined measurement regions are arranged in the second substrate, and
wherein at least one photosensor is in the plurality of predetermined measurement regions.

17. The microfluidic device according to claim 16,
wherein the at least one photosensor comprises a photodiode and a thin film transistor for controlling on and off of the photodiode,
wherein the photodiode comprises a PIN type photodiode, and
wherein the thin film transistor comprises an alpha-Si type thin film transistor.

18. The microfluidic device according to claim 16,
wherein the first substrate and the second substrate respectively comprise a glass plate, a dielectric layer and a hydrophobic layer arranged from outside to inside,
wherein the hydrophobic layer comprises a Telfon material to facilitate the liquid to move within the microfluidic device,
wherein the microfluidic device further comprises two drive electrodes respectively formed on the first substrate and the second substrate, and
wherein a first drive electrode is connected to a drive power supply and a second drive electrode is grounded, thereby driving the liquid to move within the microfluidic device.

19. The microfluidic device according to claim 16,
wherein the at least one photosensor comprises a plurality of photosensors in an array,
wherein an input end of each photosensor of the plurality of photosensors in a same row is connected to a same gate line, and
wherein an output end of each photosensor in a same column is connected to a same data line to acquire a plurality of photocurrent values.

20. The microfluidic device according to claim 16, wherein at least one temperature sensor is further provided in the plurality of predetermined measurement regions for measuring a temperature of the liquid.
